(19) United States
(12) Patent Application Publication
(10) Pub. No.: US 2007/0174253 A1
(43) Pub. Date: Jul. 26, 2007

(54) Online marketplace for animal genetics

(76) Inventors: Michael Hodnett, Mill Valley, CA (US); Louis Hawthorne, Mill Valley, CA (US)

Correspondence Address: HELLER EHRMAN LLP, 4350 LA JOLLA VILLAGE DRIVE #700, 7TH FLOOR, SAN DIEGO, CA, 92122, US

(21) Appl. No.: 11/607,598

(22) Filed: Dec. 1, 2006

Related U.S. Application Data
(60) Provisional application No. 60/742,136, filed on Dec. 1, 2005.

(51) Int. Cl. G06F 17/30

(52) U.S. Cl. 707/3

(57) ABSTRACT

An Internet-based marketplace is provided for animals, gametes and embryos wherein a database retains specific genetic identifiers correlated to the animals, embryos and gametes. A method, an apparatus, a server and a client are provided that allow a remote user to submit a query on one or more genetic identifiers to a centralized database located on the server for the purpose of allowing a user to identify matching stock, to certify stock such as to reduce fraud, to report lost or found stock, to trade stock by either fixed priced selling or auction, and to facilitate shipment of stock. An animal can be identified and a cloned embryo prepared and shipped to the requester such as in a specialized shipping container that stabilizes the cloned embryo.

### REFERENCE TO PRIORITY DOCUMENT

This application claims the benefit of priority of U.S. Provisional Patent Application Ser. No. 60/742,136 entitled “ONLINE MARKETPLACE FOR ANIMAL GENETICS”, by Michael Hodnett and Louis Hawthorne, filed Dec. 1, 2005, herein incorporated by reference.

### BACKGROUND OF THE INVENTION

Animal breeders provide animal buyers with verbal assurance that the animals being sold are as represented, along with written pedigree documentation from an animal registry organization. The pedigree documentation is typically based on “family tree” information and is not based on DNA testing. Given that animals with specific pedigrees have greater economic value than others, fraud is a constant problem in the sale of animals by breeders.

With agricultural animal species, there is currently no easy, centralized, DNA-specific way to locate animals meeting specific criteria, and there is no way to then purchase or lease the located animals for breeding purposes, or order embryos or gametes derived from those animals. Some animal owners have printed catalogs and others profile their animals on websites, but without any DNA identification or certification, nor DNA-based disease screening, nor any kind of search feature for specific traits or certifications. In addition, because individual breeders tend to be in singular, dispersed locations, there is no easy way for prospective customers to locate animals meeting their criteria within their areas. Under the current approach, prospective customers tend to select either local animals having genetics that are less than ideal, or they select animals with genetics that meet their criteria but can not be as conveniently located as other animals, of which they are unaware.

Under the current scenario, when a customer determines what animal possesses the genetics he wishes to introduce into his breeding stock, the animal owner ships either the desired animal itself for breeding, or, more recently, produces or arranges for production of a clone animal derived from the desired animal, and then ships the clone to the customer. Both cases involve shipping live animals, which for large animals such as cattle, pigs, and horses, results in large shipping fees.

Thus, there are needs for more convenient locating, purchasing, and trading in animals having a specified genetic profile. The present invention satisfies these needs as well as others.

### SUMMARY OF THE INVENTION

Provided herein is a method for receiving an access request message at a server from at least one remote user via a communications network, transmitting by the server an access enabling message to the remote user via the communications network, the access enabling message permitting the remote user to submit a query on one or more genetic identifiers to a database located on the server, the data in the database including at least one genetic identifier and at least one non-genetic identifier corresponding to at least one registry ID, each registry ID corresponding to an animal, embryo or one or more identical gametes, searching the database for one or more registry IDs by the at least one or more corresponding genetic identifier, compiling a report on the server from the accessed database, the report identifying the one or more registry IDs with corresponding one or more genetic identifiers and one or more non-genetic identifier by at least one report result and transmitting from the server the compiled report to the remote user over the communications network.

Also provided is a communications network having one or more clients, a server communicating with the one or more clients over a communications network, the server configured to receive an access request message from a client via the communications network, transmit an access enabling message to the client via the communications network, the access enabling message permitting the client to submit a query on one or more genetic identifiers to a database residing on the server, the data in the database including at least one genetic identifier corresponding to at least one registry ID, each registry ID corresponding to an animal, embryo or gamete, the server further configured to query the database for one or more registry IDs with at least one corresponding genetic identifier in response to receiving one or more queries from the one or more clients, compile a report from the database, the report identifying the one or more registry IDs with corresponding one or more genetic identifiers by at least one report result, and transmit the compiled report to the client over the network.

Also provided is a server having a network interface adapted to receive one or more queries from one or more clients over a network, a datastore having a database including at least one genetic identifier and one non-genetic identifier corresponding to at least one registry ID, each registry ID corresponding to an animal, embryo or gamete, a processor communicating with the network interface and the datastore, the processor adapted to receive a query on one or more genetic identifiers, querying the database for one or more registry IDs with at least one or more corresponding genetic identifier, compile a report from the accessed database, the report identifying the one or more registry IDs with corresponding one or more genetic identifiers by at least one report result, and transmit the compiled report to the remote user over the network via the network interface.

Also provided is a client having a network communication interface adapted to communicate with a server over a communications network, the server having a datastore and the datastore having a database including at least one genetic identifier and one non-genetic identifier corresponding to at least one registry ID, each registry ID corresponding to an animal, embryo or gamete, a processor communicating with the network interface, the processor configured to query the database across the network.

### BRIEF DESCRIPTION OF THE DRAWINGS

Various embodiments of the present invention taught herein are illustrated by way of example, and not by way of limitation, in the figures of the accompanying drawings, in which:

FIG. 1 is an illustration of a computing apparatus.

FIG. 2 is an illustration of a communications network.

FIG. 3 is a screen shot of a page provided by “Compass Rose Cattery”

FIG. 4 is a screen shot of a “Feline Finder” display window.

FIG. 5 is a screen shot of a “Feline Finder” data entry and subsequent database search result.

FIG. 6 is a screen shot of a page that shows details of an animal located in the search results.

FIG. 7 is a screenshot of Certificate of DNA Identification.

FIG. 8 is a screenshot of a control panel that allows breeders to list their cats as “available” in Feline Finder, send email to prospective clients and transfer a copy of their cat's DNA ID records to purchasers.

FIG. 9 is a screenshot of a search dialog.

FIG. 10 is a screenshot of a search result.

FIG. 11 is a screenshot showing the details from a search result.

FIG. 12 is a screen shot of a Certificate of Parentage Analysis.

FIG. 13 is a screen shot of a Certificate of Inherited Disease Testing.

FIG. 14 is a screen shot of a Certificate of DNA Preservation.

FIG. 15 shows steps in backend sales processes that include Outgoing kit and Batches processing.

FIG. 16 shows steps in backend laboratory processes that include FTA Kit receipt and DNA ID test sample processes.

FIG. 17 shows steps in backend laboratory processes that include Parentage analysis sample processing and PKD test sample processing.

### DETAILED DESCRIPTION

In accordance with the invention, an Internet-based marketplace is provided for animals, gametes and embryos featuring specific traits, which can be certified as DNA-tested to certify identity and pedigree, and which can also be screened for certain inherited diseases. In an embodiment, the marketplace is enabled through communications network from a DNA analysis device to the Internet, whereby users can receive DNA analysis results online. The marketplace provides a way for animal breeders that trade virtually any species to store DNA certifications in a database, which can then be searched by people who are looking to purchase DNA-certified animals, gametes (sperm or eggs), or embryos, which can be produced by in vitro fertilization (IVF) or cloning. In another embodiment, DNA certification testing services can be provided by the marketplace maker.

When users locate an animal via the database, they can, in an embodiment, view its DNA identification and other certifications, a list of traits, image(s) of the animal, and also the contact information of the breeder or owner of the animal. When an animal is sold, the user who ordered the DNA analysis can transfer a copy of the animal's DNA certificate(s) to the buyer.

Breeders can search the database to identify animals that would be genetically suitable breeding mates for their animal(s). When a potential breeding mate is identified, the DNA of the breeder's animal can be compared to the DNA of the identified breeding mate. This comparison provides the breeder with data indicating how closely related his animal is to the prospective breeding mate. This information helps breeders produce progeny that are as genetically diverse as possible and will thereby reduce genetic inbreeding.

A registry identification (registry ID), which can be a number or other unique identifying symbol or symbols, is correlated with each animal, or an embryo or gamete thereof, in a database. An animal can be a companion animal, a sport animal, a farm animal and the like, such as a canine, a feline, equine, bovine, caprine, ovine, porcine, a zoo animal or wildlife. This list is not meant to be limiting. An embryo or gamete can mean either a single embryo or gamete or a plurality of identical embryos or identical gametes. A gamete is a mature sexual reproductive cell, as a sperm or egg, that can unite with another cell to form a new organism. The animal, clone or gamete can be a clone. A clone is a cell, cell product, or organism that is genetically identical to the unit or individual from which it was derived. Methods of cloning animals are known to the skilled artisan and are disclosed in, for example, U.S. Pat. No. 6,548,741. The embryo can also be generated by in vitro fertilization (IVF) or by natural conception and retrieved by flushing.

One or more genetic identifiers can be associated with an animal, embryo or gamete. A genetic identifier is a property of the animal, embryo or gamete based on its genetic material. Genetic material is the nucleic acid sequence of the individual animal, embryo or gamete. The nucleic acid can be DNA or RNA. The genetic identifier can be a genotype that includes, but is not limited to, a nucleic acid sequence, a mutation in the nucleic acid sequence, a polymorphism, a single nucleotide polymorphism, an allele, a recombinant event, gene amplification, a gene deletion, or a level of nucleic acid expression. A genetic identifier can also be a gene product such as a protein and can include mutant proteins and protein expression level. The genetic identifier can be a phenotype such as breed type, pedigree (a family lineage), predisposition to disease, or physical conformation. The genetic identifier can be a phenotype such as food quality or heat tolerance.

Breed type can be, for example, Afghan Hound, Airedale Terrier, American Pit Bull Terrier, Basset Hound, Beagle, Boston Terrier, Chihuahua, Chinese Crested (hairless), Cockapoo, Cocker Spaniel, Dachshund, Dalmatian, Dingo, Doberman Pinscher, Fox Terrier, German Shepherd, Golden Retriever, Great Dane, Irish Setter, Italian Greyhound, Jack Russell Terrier, Keeshond, Labrador Retriever, Lhasa Apso, Old English Sheepdog, Papillon, Pekingese, Pomeranian, Poodle, Pug, Queensland Heeler, Rhodesian Ridgeback, Rottweiler, Saint Bernard, Shar-Pei, Siberian Husky, Vizsla, Wolf Hybrid, Yorkshire Terrier, and other dog breeds such as those recognized by the American Kennel Club (AKC). Breed type can be, for example, Abyssinian, American Bobtail, American Curl, American Shorthair, American Wirehair, Balinese, Bengal, Birman, Bombay, British Shorthair, Burmese, California Spangled Cat, Chantilly/Tiffany, Chartreux, Color point shorthair, Cornish Rex, Cymric, Devon Rex, Domestic Longhair, Domestic Shorthair, Egyptian Mau, European Burmese, Exotic, Havana Brown, Himalayan, Japanese Bobtail, Javanese, Korat, LaPerm, Maine Coon, Manx, Munchkin, Nebelung, Norwegian Forest Cat, Ocicat, Oriental, Persian, Pixie-bob, Ragamuffin, Ragdoll, Russian Blue, Scottish Fold, Selkirk Rex, Siamese, Siberian, Singapura, Snowshoe, Somali, Sphynx, Tonkinese, Turkish Angora, Turkish Van and other cat breeds such as those recognized by the Cat Fanciers Association (CFA). Breed type can be, for example, Angus, Ankole, Aryshire, Balancer, Barzona, Bazadais, Beefalo, Beefmaster, Belgianlue, Beltedalloway, Blonde'Aquitaine, Bluegrey, Boran, Braford, Brahman, Brangus, Braunvieh, Britishhite, Brownwiss, BueLingo, Charbray, Charolais, Chiangus, Clubalves, Commercial, Corriente, Devon, Dexter, Droughtmaster, Englishonghorn, Galloway, Gascon, Gelbvieh, Gir, Guernsey, Hereford, Highland, Holstein, Irishlack, Jersey, Kerry, Limousin, Lincolned, Lowline, Luing, Maine-Anjou, Marchigiana, Murrayrey, Nelore, Normande, Marthenais, Piedmontese, Pinzgauer, Randall, Recreationalattle, Redoll, Romagnola, Salers, Salorn1, Santaertrudis, Senepol, Shetland, Shorthorn, Simbra, Simmental, Southevon, Sussex, Tarentaise, Texas Longhorn, Wagyu, Watusi, Welshlack, Whitebredhorthorn, Zebu and other cattle breeds such as those recognized by American Angus Association, American Hereford Association, Red Angus Association of America, American Wagyu Association, The Holstein Association, The American Guernsey Association, American Jersey Cattle Association. Breed type can be, for example, Arcott, Blackbelly, Black Welsh Mountain, Bluefaced Leicester, Border Leicester, California Red, California Variegated Mutant, Cheviot, Cotswold, Dorset, Finnish Landrace, Galway, Hampshire, Icelandic, Jacob, Karakul and other sheep breeds such as those recognized by the Bluefaced Leicester Union of North America Icelandic Sheep Breeders of North America, North American Shetland Sheep Association, American Black Sheep Registry, American Finnsheep Breeder's Association, and California Red Sheep Registry, Inc. Breed type can be, for example, Alpine, Altai Mountain, American Cashmere, Anatolian Black, Anglo-Nubian (Nubian), Angora, British Alpine, Canary Island, Corsican, Damascus, Golden Guernsey, Hexi Cashmere, Pygmy, Russian White, San Clemente, Somali, Tennessee Fainting, West African Dwarf, White Shorthaired Goat, Yemen Mountain, Zalawadi and other goat breeds such as those recognized by the American Boer Goat Association, American Dairy Goat Association, American Goat Society, International Dairy Goat Registry (IDGR, Inc.), and National Pygmy Goat Association. Breed type can be, for example, American Landrace, American Yorkshire, Bantu, Berkshire, British Lop, Dutch Landrace, French Landrace, German Landrace, Guinea Hog, Hampshire, Hereford, Hezuo, Iberian, Italian Landrace, Middle White, Mulefoot, Norwegian Landrace, Oxford Sandy and Black, Pietrain, Red Wattle, Saddleback, Swedish Landrace, Tibetan, Vietnamese Potbelly, Welsh, Wuzhishan and other pig breeds such as those recognized by the Certified Pedigreed Swine Association, National Show Pig Association, and National Swine Registry. Breed type can be, for example, Abyssinian, Albanian, Altai, American Creme and White, American Walking Pony, Andalusian, Appaloosa, Arabian, Azteca, Belgian, Chincoteague Pony, Clydesdale, Dutch Draft M, Egyptian, Golden American Saddlebred, Gotland, Hokkaido, Icelandic, Jutland, Kazakh, Latvian, Lithuanian Heavy Draft, Lipizzan , Lusitano, Mongolian, Mustang, Newfoundland Pony, Nordland, Orlov Trotter, Paint, Palomino, Peruvian Paso, Pinto, Przewalski, Quarter Horse, Racking Horse, Shetland Pony, Shire, Somali Pony, Tennessee Walking Horse, Thoroughbred, Welsh Pony, Xilingol and other horse breeds such as those recognized by the American Quarter Horse Association (AQHA), Paso Fino Horse Association, Inc. (PFHA), United States Lippizan Registry, Arabian Horse Registry of America, Inc., World Arabian Horse Organization, and American Morgan Horse Association. Breed type can be from other animal species as well as this list is meant to be nonlimiting.

An animal type can be a sire, a dam, a kitten, a puppy, a calf, a kid, a lamb, a colt, retired or other status indicating an animal's stage of life.

Predisposition to disease can be any genetic alteration that can potentially lead to a disease such as hip dysplasia, obesity, diabetes, and cancer such as that correlated to an oncogene. An example of disease in cats resulting from a genetic alteration is Polycystic Kidney Disease (PKD). Examples of diseases in dogs resulting from genetic alteration include Polycystic Kidney Disease, Phosphofructokinase Deficiency, Pyruvic Kinase Deficiency, von Willebrand's Disease, and Progressive Retinal Atrophy. Examples of diseases in cattle resulting from genetic alteration include Alpha-mannosidosis, Beta-mannosidosis, Bovine Lymphocyte Adhesion Deficiency (BLAD), Deficiency of Uridine Monophosphate Synthetase, Dwarfism, Factor IX Protoporphyria, and Weaver Syndrome. Examples of diseases in horses resulting from genetic alteration include Hyperkalemic periodic paralysis (HYPP) and Lethal White Syndrome.

Conformation relates to an animal's particular physical characteristics. For example, the American Kennel Club (AKC) has standards that describe the ideal size, color, and temperament of each breed, as well as correct proportion, structure, and movement.

For each animal, embryo or gamete, one or more non-genetic identifiers can be associated. A non-genetic identifier is a property of the animal, embryo or gamete independent of its genetic material. The non-genetic identifier includes, but is not limited to: descriptive data of animals and embryos/gametes derived from them, owners of animals, breeding organizations, registries of animals, and financial transaction data.

Animal, embryo, or gamete descriptive data can include registry ID, DNA ID, date of birth, gender, animal type, coat color, microchip number, tattoo number, image, certificate number, certificate type, geographic location, or available tag. Animal, embryo, or gamete descriptive data can also include height, weight, growth characteristics, feedlot location, feed formula, production data, border crossings, shipping data, awards data, disease status, vaccination data, medical record data, or storage data (such as for the embryo or gamete).

The owner information can include owner name, owner ID, owner transfer data, owner address, or owner certificate. Owner ID can be a number or combination of symbols that uniquely identify the owner.

DNA ID can be a number or combination of symbols that uniquely identify nucleic acid. Image can, for example, be a photograph of the animal, the owner or the facility in which the animal is kept. Geographic location can be, for example, continent, country, county, city, street address or room number. Available tag can be an indicator (such as a yes/no flag) as to whether the animal, embryo or gamete is available, for example, for purchase by a buyer or available as breeding stock.

Disease status can be results of a disease or parasite test such as for Hoof and Mouth disease, screwworm or bovine spongiform encephalopathy (BSE). Storage conditions can be data on how an embryo or gamete is being stored such as temperature, facility, rack ID in a storage cane and the like.

Registries of animals can include, for example, the Cat Fanciers Association (CFA), American Kennel Club (AKC), the Holstein Association, and others.

Financial transaction data can be, for example, credit or debit card information or can be purchasing or auction information. Auction information can include a set price, a reserve price or a bid price or other auction information such as time of start of auction, time at end of auction, elapsed time, for the auctioning of an animal, embryo or gamete. Storage data can be, for example, information regarding the conditions on how an embryo or gamete is stored or shipped.

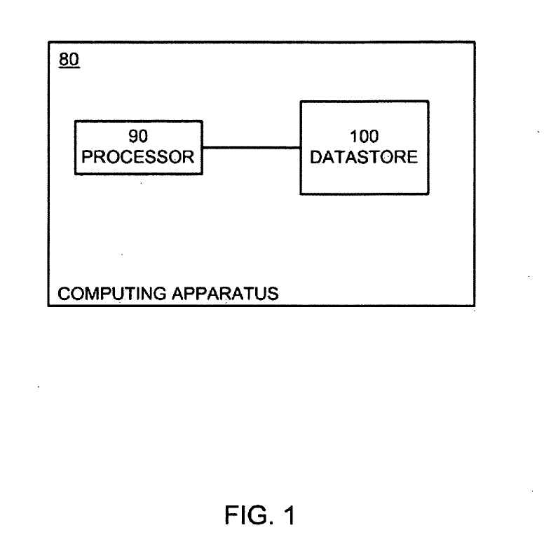

FIG. 1 illustrates a computing apparatus consistent with one embodiment of the invention. The computing apparatus 80 can be a general purpose computer comprising a processor 90 and a datastore 100. It is understood that a computing apparatus 80 would need a number of other components that are not depicted in FIG. 1 to be operable. These components are omitted for convenience. It is understood that computing apparatus 80 can further include a network adapter in some embodiments. In this embodiment a computer software product can be stored on datastore 100. The computer software product can comprise machine executable instructions that are executed by processor 90. Computing apparatus 80 can be configured to execute the methods described herein. Additionally, Computing apparatus 80 can be configured to execute customer specific software that is derived from industry standard software applications and skinned models derived consistent with the embodiments described herein. In some embodiments, datastore 100 can include a datastore as described above. The Computing apparatus 80 can further be configured to include an output device such as a graphics display or audio device.

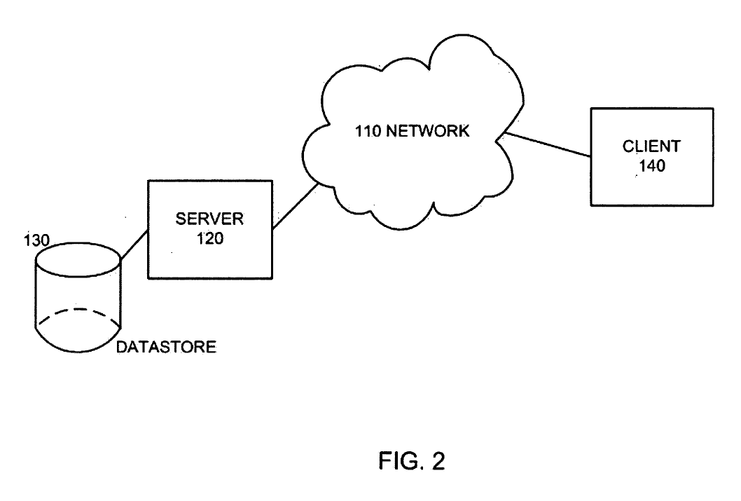

Referring to FIG. 2 which illustrates a network 110 consistent with various disclosed aspects and features. FIG. 2 illustrates a client-server network wherein datastore 130 can reside on server 120. In other embodiments, not illustrated, datastore 130 can reside on a client device 140. Server 120 and client 140 can be configured to execute software products derived from skinned models and software applications. Additionally, server 120 and client 140 can be utilized to practice the methods described herein. The client device 140 can further be configured to include an output device such as a graphics display or audio device.

As is known in the art communications network 110 can comprise a number of components that are not depicted. Communications networks 110 can be classified in a number of ways. A communications network 110 can be classified by the range supported by the underlying technology. For example, some communications network 110 technologies are designed to provide communication across significant ranges. The Public Switched Telephone Network (PSTN) is a communications network 110 with almost global reach. Significant portions of the PSTN comprise a wired infrastructure. Portions of the PSTN comprise optical fiber media. Other portions of the PSTN infrastructure can include microwave or radio frequency links communicating across a wireless medium. Wireless and cellular telephone networks interface to the PSTN.

Other types of data communications networks 110, can interface with voice communications networks 110. These communications networks 110 can have essentially global ranges, such as the Internet. These communications networks 110 can include wireless metropolitan area network technologies such as the technology currently referred to as WiMax. Metropolitan area networks 110 can include wired or optical media as well as a wireless medium. Local area networks 110 can be wired, typically employing twisted-pair wired media, or wireless. Wireless local area networks (WLANs) can include networks 110 employing wireless technologies like Direct Sequence Spread Spectrum (DSSS) or Orthogonal Frequency Division Multiplexing (OFDM). These two wireless technologies are currently the basis for well known WLAN technologies commonly referred to as WiFi or 802.11a, b, and g. Wireless networks can additionally be classified as Wireless Personal Area Networks (WPAN). Typically in WPAN technologies the data rates can be quite significant but the ranges can be limited to under 20 meters. One example of WPAN technology includes a frequency hopping spread spectrum technology, such as the technology currently known as BLUETOOTH (BLUETOOTH is a registered trademark of the Bluetooth Special Interest Group). Other WPAN technologies that are currently under development include Ultra-Wideband, which currently is being implemented as an impulse technology, a DSS technology, and a frequency hopping OFDM technology.

In an embodiment, a method is performed for receiving an access request message from at least one remote user via a communications network, transmitting an access enabling message to the remote user via the communications network, the access enabling message permitting the remote user to submit a query on one or more genetic identifiers to the database, the data in the database comprising at least one genetic identifier and at least one non-genetic identifier corresponding to at least one registry ID, each registry ID corresponding to an animal, embryo or one or more identical gametes, searching the database for one or more registry IDs by the at least one or more corresponding genetic identifier, compiling a report from the accessed database, the report identifying said one or more registry IDs with corresponding one or more genetic identifiers and one or more non-genetic identifier by at least one report result and, transmitting the compiled report to the remote user.

The compiled report can be filtered, such as certain data removed or inserted. This can be accomplished by adding or removing select data prior to compiling a report. This can be accomplished by adding or removing select data from a compiled report before transmission to the remote user. For example, sensitive identification data can be removed from a compiled report to protect the identity of an owner or to prevent a user from viewing sensitive financial data. Other methods of filtering are known by those skilled in the art.

The remote user can be a buyer or a seller of the animal, embryo or gamete. In a sale, wherein there is at least one buyer for a seller, the seller can set a price and the buyer can buy the animal, embryo or gamete at the set price. In an auction, the seller can set a reserve and one or more users can submit a bid. Auction processes are known in the art. The highest bidder is then identified at the end of the auction and the animal, embryo or gamete can be sent to a designated location. The embryo or gamete can be sent in a specialized shipping container that stabilizes the embryo or gamete. The embryo or gamete shipment can also include a DNA certificate to guard against fraud. The time frame (closing time) of the auction can be specified. Online auctions such as eBay, UBid, Yahoo! Auction and MercExchange are known in the art.

The remote user can be an owner who has lost the animal, embryo or gamete (either misplaced or stolen) or one that has found an animal, embryo or gamete. The user can submit a query to the database containing genetic or non-genetic identifier data causing compiling of a report identifying a matching animal, embryo or gamete. A notification can be transmitted to the finder or owner that the animal, embryo or gamete has been lost or found, respectively. In another embodiment, the found animal is subjected to a genetic test and the genetic test data is submitted as a query.

An embodiment of the invention includes a communications network having one or more clients, a server communicating with the one or more clients over a communications network, the server configured to receive one or more queries from the one or more clients, receive an access request message from a client via the communications network, transmit an access enabling message to the client via the communications network, the access enabling message permitting the client to submit a query on one or more genetic identifiers to the database, the data in the database comprising at least one genetic identifier corresponding to at least one registry ID, each registry ID corresponding to an animal, embryo or gamete, querying the database for one or more registry IDs with at least one or more corresponding genetic identifier, compiling a report from the accessed database, the report identifying said one or more registry IDs with corresponding one or more genetic identifiers by at least one report result and transmitting the compiled report to the client. The compiled report can be filtered.

An embodiment of the invention includes a server having a network interface adapted to receive one or more queries from one or more clients over a network, a datastore comprising a database comprising at least one genetic identifier and one non-genetic identifier corresponding to at least one registry ID, each registry ID corresponding to an animal, embryo or gamete, and a processor communicating with the network interface, the processor adapted to receive a query on one or more genetic identifiers, querying the database for one or more registry IDs with at least one or more corresponding genetic identifier, compiling a report from the accessed database, the report identifying said one or more registry IDs with corresponding one or more genetic identifiers by at least one report result, and transmitting the compiled report to the remote user.

In an embodiment, the invention includes a client having a network communication interface adapted to communicate with a server over a communication network, the server comprising a datastore and the datastore comprising a database comprising at least one genetic identifier and one non-genetic identifier corresponding to at least one registry ID, each registry ID corresponding to an animal, embryo or gamete, and a processor communicating with the network interface, the processor configured to query the database across the network.

The client can further be configured to accept data from a bioanalytical device or from a computer or datastore that has such data from a bioanalytical device or manually inputted results from an analysis. The analysis can be based on nucleic acid, polypeptide, or other macromolecule. Data derived from nucleic acid analysis can be obtained by such methods that include DNA sequencing, PFGE analysis, allele-specific oligonucleotide (ASO), dot blot analysis and denaturing gradient gel electrophoresis, and are well known to the artisan. Nucleic acid analysis via microchip technology and TaqMan assay are also well known in the art. Nucleic acid analysis can determine, for example, mutation, gene amplification, gene deletion, polymorphism or gene expression. Protein analysis can include, for example, immunoassay, peptide sequencing, and electrophoresis. Protein analysis can determine, for example, protein processing and modification.

### EXAMPLE 1

CATBANK

An implementation described herein will be referred to as “CatBank” and, as the name implies, involves the DNA certification of cats for prospective breeders. The cats are “purebred” or are unusual crosses or unique progeny.

In addition, although the embodiment herein is described with respect to breeders (of cats), the invention enables an online, global marketplace for animal cloning as well. A global marketplace for cloning is similar in that animals are profiled online, but the deliverable is not an animal for purchase or use for breeding, but rather a cloned embryo produced using the genetic material of the profiled animal, delivered to the customer. The cloned embryo can be transferred into a recipient animal. The recipient animal can be hormonally stimulated in order to enhance implantation. The recipient can be maintained by or near the customer.

Thus, the invention provides various scenarios for an online marketplace in which the trade of animals based on genetic identifiers is fostered. Many goods are commonly sold online, and animals are commonly identified using DNA. However, as described herein, the combination of online sale of DNA-certified animals, using online databases that are searchable by various criteria, results in novel capabilities. In this way, international animal buyers and sellers are brought together online, resulting in much faster selection of animals for use in breeding programs, and can reduce fraud. In addition, when the deliverable is a clone, delivery of cloned embryos rather than whole animals are supported at much lower cost. The cloned embryo can be shipped in a suitable embryo shipping container that stabilizes the embryo, further lowering costs and expanding marketplace reach.

An online genetics marketplace such as described herein can be better understood with reference to a global operating scenario. Many countries have use for animal genetics which do not exist within their locale; in fact, animal genetics that are common in one area can have impaired value in that location, due to saturation, yet can be scarce and of great value in other areas. With an online genetics marketplace, owners of valuable animal genetics worldwide will have an easy way to learn about, purchase, and trade animal genetics and associated certifications.

A database is used to store animal DNA certifications. The DNA certification data is controlled by the animal breeder, who can choose to make this information publicly available to buyers, who can search for animals.

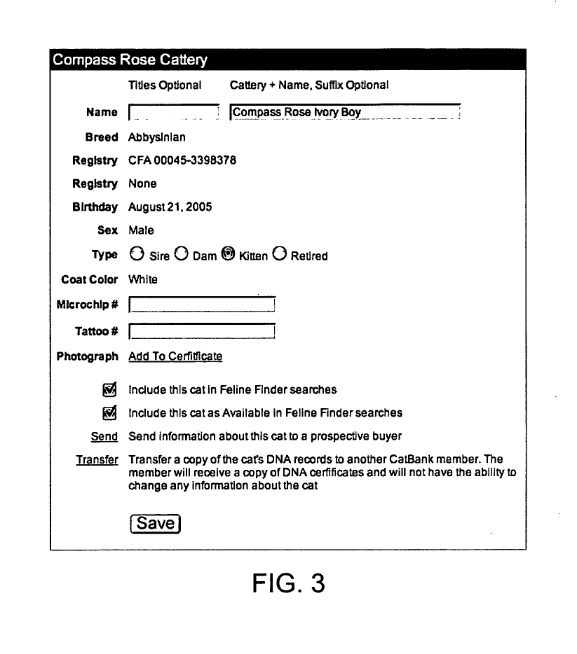

FIG. 3 shows a screen shot of a page provided by “Compass Rose Cattery” to permit online, Internet-based examination of available animals by potential buyers.

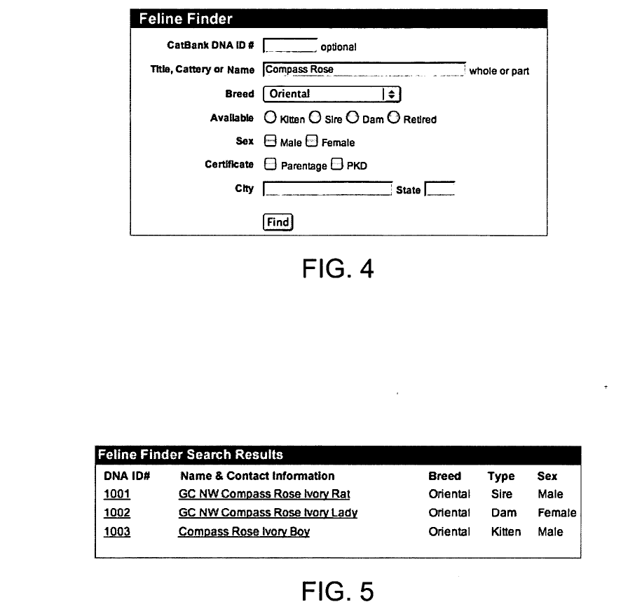

FIG. 4 is a screen shot that shows a “Feline Finder” display window, illustrating how a buyer can enter data, both genetic and non-genetic, to specify characteristics of an animal being sought.

FIG. 5 is a screen shot that shows search results of the “Feline Finder” data entry and subsequent database search result.

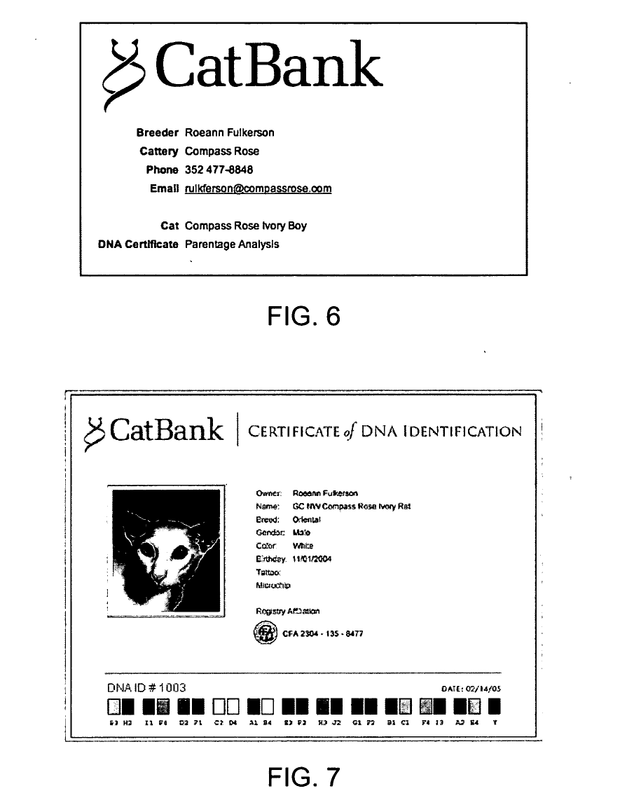

FIGS. 6 is a screen shot that illustrates details of an animal located in the search results, in the illustrated case, for the Animal called “Compass Rose Ivory Boy”.

### The CatBank Suite of DNA Services

CatBank offers cat breeders and owners a comprehensive suite of DNA services that includes DNA Identification Testing, Feline Finder, Parentage Analysis, Inherited Disease Testing and DNA Preservation services. These services can be ordered—and test results received—directly from the CatBank website at www.CatBank.org.

CatBank licenses and offers new services developed by researchers from around the world, including researchers at the BioArts Science Center. Each new service considered for inclusion on CatBank must first pass a strict evaluation process. Following are descriptions of a suite of services:

DNA Identification Testing

A DNA Identification Test produces a permanent record of an individual cat's identity. When a cat's breeder orders a DNA ID test, the breeder becomes the DNA record administrator and “cattery of record” for the life of the cat, and receives a Certificate of DNA Identification bearing a unique DNA ID (see FIG. 7).

DNA ID testing enables the cat fancy to implement a DNA Certification Program similar to those that have greatly benefited other animal registries. Such a program improves the integrity of pedigrees, feline health, and increases confidence among the purchasers of pedigreed cats. A Certificate of DNA Identification is a guarantee of a cat's identity.

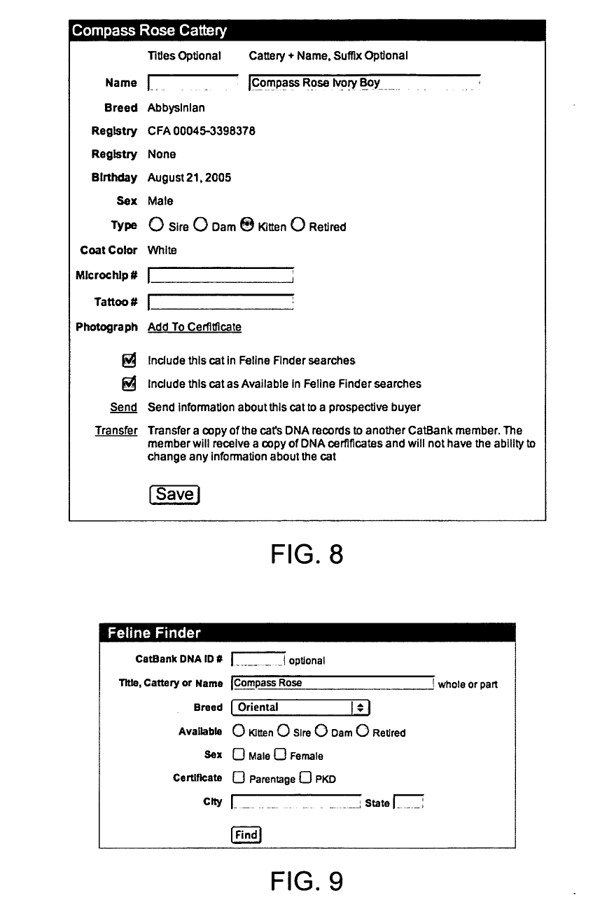

CatBank includes a simple control panel that allows breeders to list their cats as “available” in Feline Finder, send email to prospective clients and transfer a copy of their cat's DNA ID records to purchasers. See FIG. 8.

Feline Finder

Feline Finder is a tool on CatBank.org that enables the public to locate information about any cat in the CatBank database. Its features are similar to those found on the Canine Health Information Center (CHIC) website at www.caninehealthinfo.org/chicinfo.html, which is designed to assist in breeding healthy dogs.

FIG. 9 is an example of a search dialog (for Oriental cats bred by Compass Rose). As shown in the figure, the search dialog has fields for DNA ID, Title, Cattery or Name, breed type, animal type, gender of cat, Parentage Certificate, PKD Certificate, and geographic location (City and State).

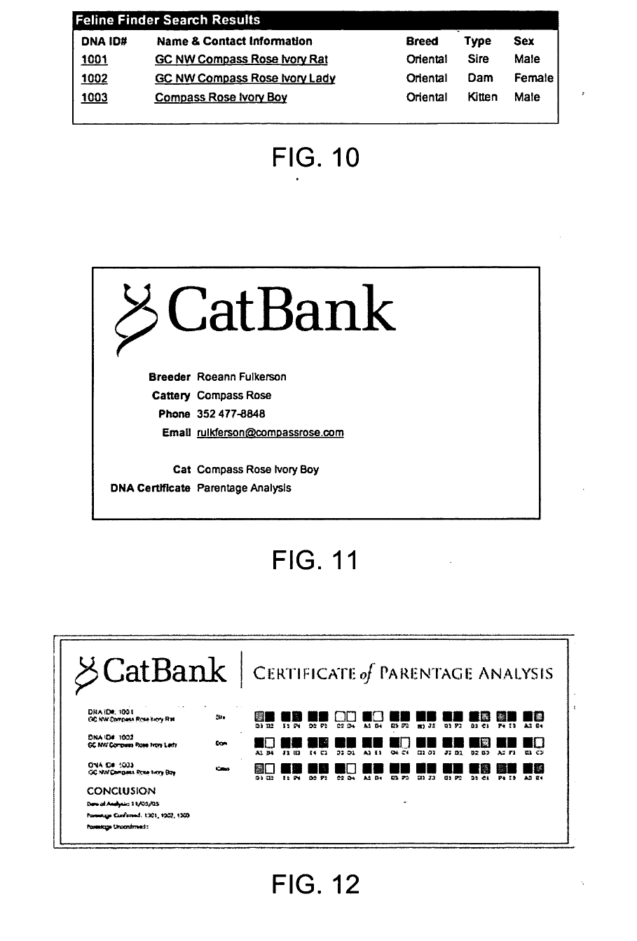

FIG. 10 shows the results of that search. As shown in the figure, a list of matching cats is shown with the following information: DNA ID, Name and Contact Information, breed type, animal type and gender of cat.

FIG. 11 is a screenshot showing the details of one of the cats located by that search. As shown in the figure, Breeder name, Cattery, Phone number, e-mail address, Cat name and DNA certificate is displayed.

To be included in Feline Finder, a cat is DNA ID tested and assigned a unique DNA ID number. Inclusion in Feline Finder is optional, and information about each cat is displayed at the sole discretion of the cat's DNA record administrator.

Parentage Analysis

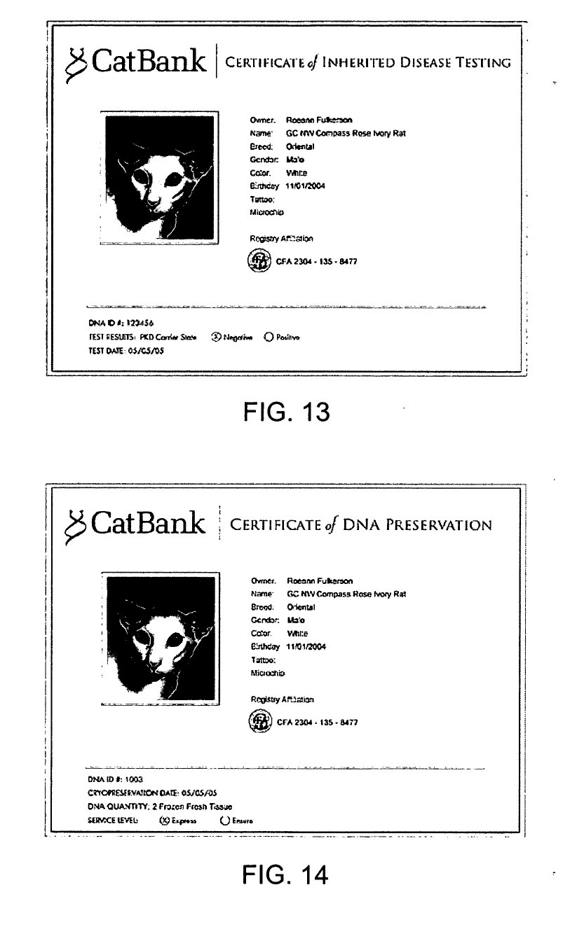

Parentage can be confirmed, unconfirmed or excluded by comparing the DNA ID markers of the sire and dam to those of the kitten. Because these markers are inherited in pairs, one marker must come from the sire and one must come from the dam for each kitten. When all markers of the sire and dam match those of the kitten, parentage is considered “confirmed.” When one marker doesn't match, parentage is considered “unconfirmed” and the cat can require further analysis. When more than one marker doesn't match, parentage is considered “excluded.” The CatBank Parentage Analysis service confirms parentage for one sire, one dam and up to 7 kittens at a time. FIG. 12 shows a screen shot of a Certificate of Parentage Analysis. As shown in the figure, genotype panels are displayed for the dam, sire and kitten to show parentage.

It is recommended that breeders get a DNA ID test for all of their breeding cats to make sure the offspring can be included in a parentage analysis. Because the DNA ID markers for all cats are saved in a database, the CatBank parentage analysis service offers flexible ways for breeders to use this service.

Option 1: Breeders can provide DNA ID and Parentage Analysis Certificates to kitten purchasers. This option requires breeders to buy a DNA ID test for each kitten and the Parentage Analysis service for an entire litter.

Option 2: Breeders can transfer a copy of the sire & dam's DNA ID Certificates to kitten purchasers on CatBank electronically. This option enables a kitten purchaser to buy a DNA ID test and parentage analysis independently.

Inherited Disease Testing

DNA tests that identify specific genetic mutations that cause disease are made available to cat breeders. These tests identify an animal's genotypic status and can reduce inherited disease from breeding programs. When a breeder tests a litter early, it is possible to determine which kittens are breeding candidates and which to place into non-breeding situations, with the ultimate goal of breeding only genetically normal parents that produce normal kittens. Because DNA testing is highly accurate and low cost, the cost/benefit ratio to breeders is clear.

CatBank offers the Feline PKD Test. Polycystic Kidney Disease is a progressive disease that manifests slowly, enlarges kidneys, reduces kidney function and ultimately results in organ failure. PKD is caused by a known gene mutation, readily identified through DNA testing.

A PKD test that is used in conjunction with parentage analysis is used to clear first-generation kittens when the sire & dam are tested and found to be negative. This PKD test is available for Persians, Exotics, Himalayans and Persian out-crosses. To order this service, a cat is DNA ID tested or the service is ordered as a PKD & DNA ID bundle. FIG. 13 shows a screen shot of a Certificate of Inherited Disease Testing. As shown in the figure, an image of the cat, the owner name, the cat name, the breed type of the cat, the gender of the cat, the color of the cat, the birth date of the cat, tattoo field, microchip field, registry affiliation, DNA ID, PKD carrier state and date of DNA test are displayed.

DNA Preservation

DNA Preservation offers breeders the opportunity to store the genetics of extraordinary cats for a variety of uses. Benefits of DNA preservation include:

Preservation of extraordinary or rare genetic traits;

Permanent resource and unlimited supply of valuable DNA;

Increased future breeding options, such as the reintroduction of an extraordinary cat's genetics back into a breeding program through cloning;

Potential for use in genetic enhancement and regenerative therapies;

Potential to sell and derive revenue from the DNA of an extraordinary cat.

FIG. 14 shows a screen shot of a Certificate of DNA Preservation. As shown in the figure, the owner name, the cat name, the breed type of the cat, the gender of the cat, the color of the cat, the birth date of the cat, a tattoo field, a microchip field, a registry affiliation, a DNA ID, a cryopreservation date, a DNA quantity (2 frozen fresh tissue), and a service level are displayed.

The collection, storage and use of DNA varies depending on whether it is done for DNA Preservation or for DNA testing:

| | DNA | DNA |
|---|---|---|
| | Preservation | Testing |
| DNA is collected from the animal by a | Yes | No |
| veterinarian through the removal of small | | |
| tissue biopsies | | |
| Tissue biopsies are cryopreserved (frozen in | Yes | No |
| liquid nitrogen) and can be thawed and used | | |
| for various services ordered by the client | | |
| DNA is contained in “live” cells and can | Yes | No |
| be used for future advanced reproductive | | |
| technologies such as regenerative disease | | |
| therapies, stem cell production and cloning | | |
| DNA is contained in “dead” cells and can | No | Yes |
| be used only for analysis purposes | | |
| DNA is collected at home with a swab and | No | Yes |
| FTA Card | | |
| DNA is stored at room temperature | No | Yes |

BreedReader

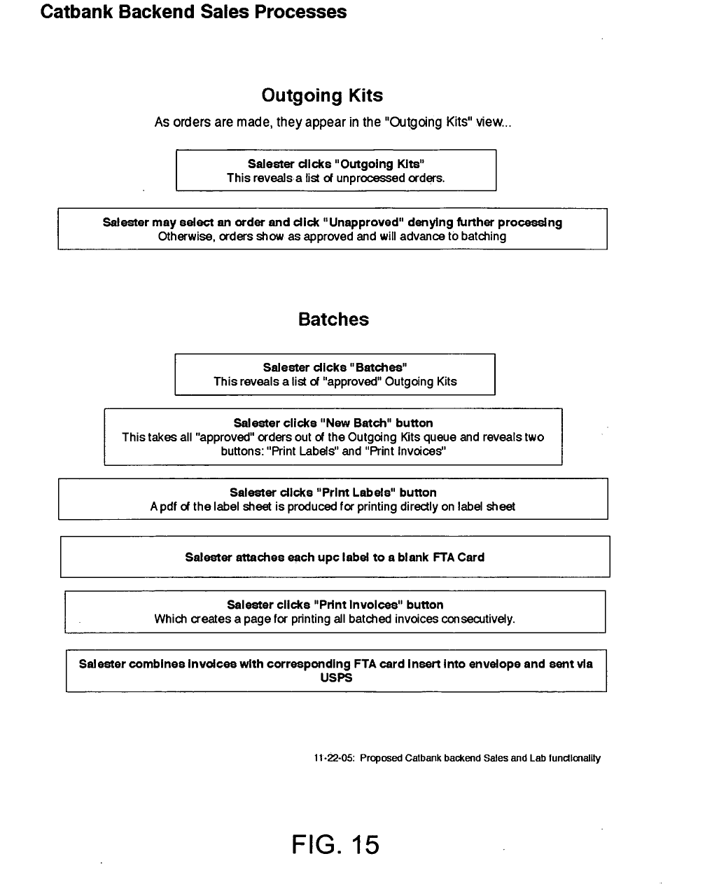

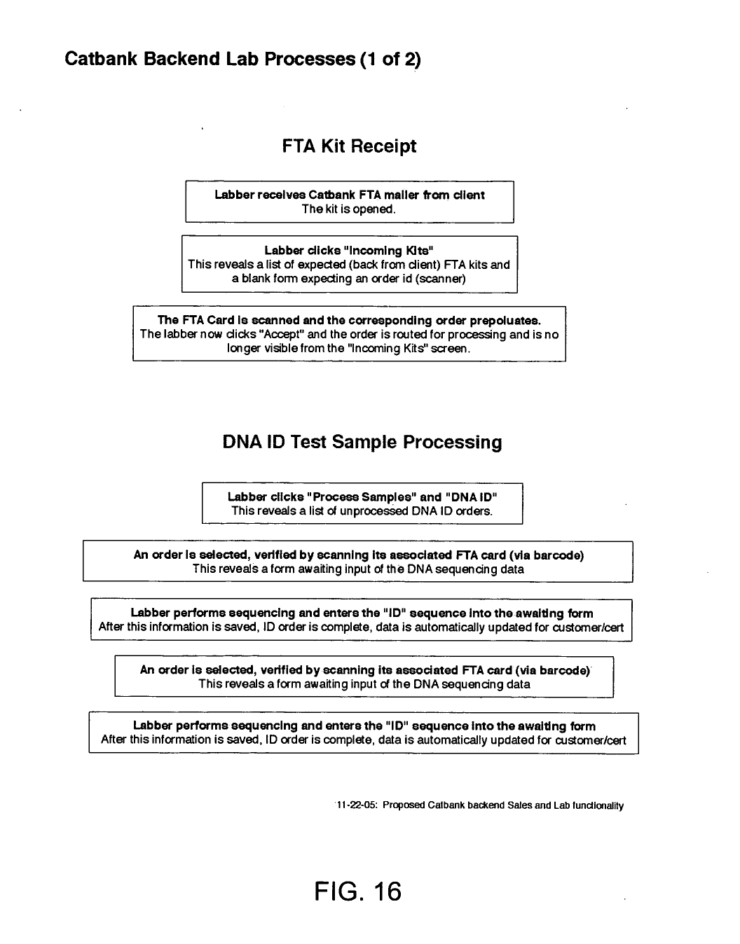

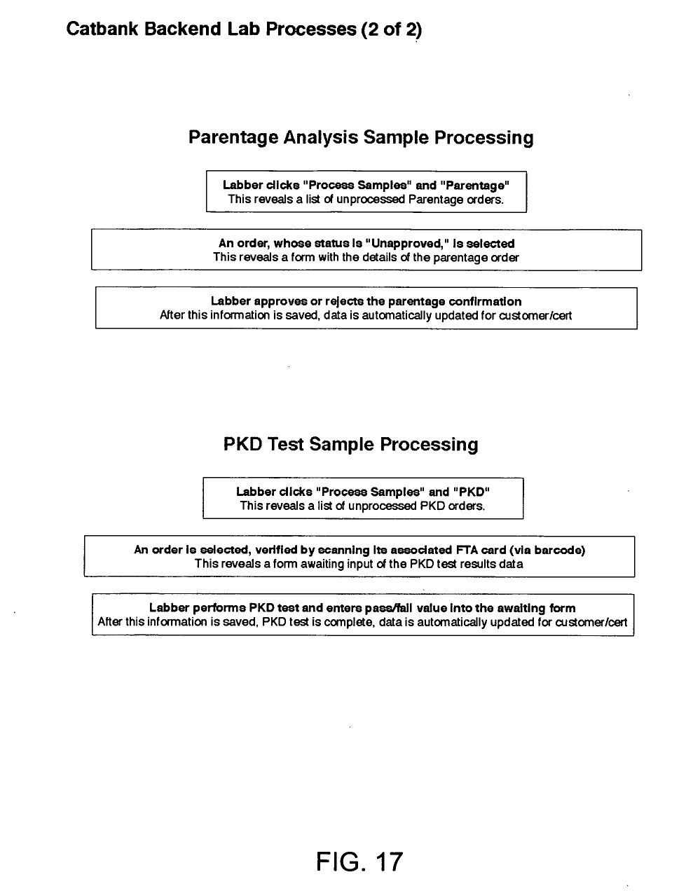

BreedReader enables cat breeders and owners to verify or identify the breed or combination of breeds that exist in an individual cat. To order BreedReader, a cat owner swabs the inside of a cat's mouth to collect cells, transfer the cells to an FTA card, and send the card to BioArts for DNA analysis. After DNA analysis, a detailed Cat Breed Profile Report is made available to the cat's owner. FIG. 15 shows steps in the CatBank backend sales processes that include Outgoing kit and Batches processing. FIG. 16 shows steps in the CatBank backend laboratory processes that include FTA Kit receipt and DNA ID test sample processes. FIG. 17 shows steps in the CatBank backend laboratory processes that include Parentage analysis sample processing and PKD test sample processing.

The present invention should therefore not be seen as limited to the particular embodiments described herein, but rather, it should be understood that the present invention has wide applicability with respect to a marketplace in animal genetics generally. All modifications, variations, or equivalent arrangements and implementations that are within the scope of the attached claims should therefore be considered within the scope of the invention.

We claim:

1. A method comprising:
receiving an access request message at a server from at least one remote user via a communications network;
transmitting by the server an access enabling message to the remote user via the communications network, the access enabling message permitting the remote user to submit a query on one or more genetic identifiers to a database located on the server, the data in the database comprising at least one genetic identifier and at least one non-genetic identifier corresponding to at least one registry ID, each registry ID corresponding to an animal, embryo or one or more identical gametes;
searching the database for one or more registry IDs by the at least one or more corresponding genetic identifier;
compiling a report on the server from the accessed database, the report identifying said one or more registry IDs with corresponding one or more genetic identifiers and one or more non-genetic identifier by at least one report result; and,
transmitting from the server the compiled report to the remote user over the communications network.

2. The method of claim 1 wherein the genetic identifier corresponds to a nucleic acid sequence, a nucleic acid mutation, a nucleic acid polymorphism, a gene amplification, a gene deletion, an allele, or a nucleic acid or polypeptide expression level.

3. The method of claim 1 wherein the genetic identifier corresponds to a breed type, a pedigree, a predisposition to a disease, a physical conformation.

4. The method of claim 1 wherein the genetic identifier corresponds a food quality or heat tolerance.

5. The method of claim 1 wherein the animal or embryo is a clone.

6. The method of claim 1 wherein the non-genetic identifier is from one or more of the group consisting of: a descriptive datum of an animal, embryo or gamete, a datum associated with an owner of an animal, embryo or gamete, a datum associated with a breeding organization, a datum associated with an animal, embryo or gamete registry, or a financial datum.

7. The method of claim 6 where the descriptive datum associated with the animal, embryo or gamete is DNA ID, date of birth, gender, animal type, coat color, microchip number, tattoo number, image, certificate number, geographic location, available tag, feedlot location, feed formula, production data, border crossings, shipping data, financial transaction data, vaccination data, medical record data, or storage data.

8. The method of claim 6 where the datum associated with an owner of animal is owner name, owner ID, owner transfer data, owner address, image, or owner certificate number.

9. The method of claim 6 wherein the financial datum is a credit or debit card datum or an auction datum.

10. The method of claim 9 wherein the auction datum is price, reserve price, starting bid, last high bid, start of auction, time at end of auction, or elapsed time.

11. The method of claim 9 further comprising:
enabling buyers and a sellers to engage in an auction to determine the highest bidder for the one or more registry IDs and wherein the compiled report includes purchase data.

12. The method of claim 3 wherein the predisposition disease is a predisposition to Polycystic Kidney Disease, Phosphofructokinase Deficiency, Pyruvic Kinase Deficiency, von Willebrand's Disease, Progressive Retinal Atrophy, Alpha-mannosidosis, Beta-mannosidosis, Bovine Lymphocyte Adhesion Deficiency, Deficiency of Uridine Monophosphate Synthetase, Dwarfism, Factor IX Protoporphyria, Weaver Syndrome, Hyperkalemic periodic paralysis or Lethal White Syndrome.

13. The method of claim 1 wherein the query uses one or more genetic identifiers from a registry ID record.

14. The method of claim 1 wherein the user is an owner of the animal, embryo, or gamete.

15. The method of claim 1 wherein the query is based on data from bioanalytical device.

16. The method of claim 1 wherein the compiled report is filtered.

17. A communications network comprising:
one or more clients;
a server communicating with the one or more clients over a communications network, the server configured to receive an access request message from a client via the communications network, transmit an access enabling message to the client via the communications network, the access enabling message permitting the client to submit a query on one or more genetic identifiers to a database residing on the server, the data in the database comprising at least one genetic identifier corresponding to at least one registry ID, each registry ID corresponding to an animal, embryo or gamete, the server further configured to query the database for one or more registry IDs with at least one corresponding genetic identifier in response to receiving one or more queries from the one or more clients;
compile a report from the database, the report identifying said one or more registry IDs with corresponding one or more genetic identifiers by at least one report result; and,
transmit the compiled report to the client over the network.

18. The communications network of claim 17 wherein the server configuration further comprises a configuration for comparing genetic identifiers between one or more registry IDs.

19. The communications network of claim 18 wherein said comparison is performed to confirm parentage.

20. The communications network of claim 17 wherein at least one client further comprises an output device.

21. The communications network of claim 17 wherein at least one client is configured to accept data from a bioanalytical device.

22. The communications network of claim 17 wherein the compiled report is filtered.

23. A server comprising:
a network interface adapted to receive one or more queries from one or more clients over a network;
a datastore comprising a database comprising at least one genetic identifier and one non-genetic identifier corresponding to at least one registry ID, each registry ID corresponding to an animal, embryo or gamete; and,
a processor communicating with the network interface and the datastore, the processor adapted to receive a query on one or more genetic identifiers, querying the database for one or more registry IDs with at least one or more corresponding genetic identifier, compile a report from the accessed database, the report identifying said one or more registry IDs with corresponding one or more genetic identifiers by at least one report result, and transmit the compiled report to the remote user over the network via the network interface.

24. A client comprising:
a network communication interface adapted to communicate with a server over a communications network, the server comprising a datastore and the datastore comprising a database comprising at least one genetic identifier and one non-genetic identifier corresponding to at least one registry ID, each registry ID corresponding to an animal, embryo or gamete;
a processor communicating with the network interface, the processor configured to query the database across the network.

25. The client of claim 24 further comprising an interface to a bioanalytical device.

26. The client of claim 24 further comprising an output device.
